(19) United States
(12) Patent Application Publication
(10) Pub. No.: US 2006/0245197 A1
(43) Pub. Date: Nov. 2, 2006

(54) Display assembly

(76) Inventors: John Collier, Menlo Park, CA (US); Israel Garcia, Newark, CA (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/390,721

(22) Filed: Mar. 28, 2006

Related U.S. Application Data
(60) Provisional application No. 60/666,099, filed on Mar. 28, 2005.

(51) Int. Cl. F21S 8/00

(52) U.S. Cl. 362/427

(57) ABSTRACT

Display assemblies and methods of displaying information are provided. A display assembly for displaying information may include a bracket adapted to be connected to shelving. The bracket may include a first support member and a second support member. The display assembly may also include a display fixture removably supported by the first support member for displaying indicia thereon and an illumination device supported by the second support member in a position to illuminate the display fixture. A method of displaying information may include connecting a first bracket to a support structure, supporting a display fixture on the first bracket, supporting an illumination device on the first bracket, connecting a second bracket to a second support structure, removing the display fixture from the first bracket, and supporting the display fixture on the second bracket.

### RELATED APPLICATIONS

The present application claims the priority of previously filed, co-pending Provisional Patent Application Ser. No. 60/666,099, filed Mar. 28, 2005, the entire contents of which are incorporated herein by reference.

### BACKGROUND OF THE INVENTION

The present application relates to display assemblies and, more particularly, to display assemblies for lighting and displaying information relating to consumer products in a retail environment.

In many retail environments, it is desirable to display product or similar information on a product rack or shelving unit so that consumers can locate desired products or read information about a product. It is also important that the information be easily viewable by consumers. Such product information can include text, prices, symbols and/or illustrations and is typically displayed near the product. Product information can be displayed in a variety of manners. In some instances, the information is displayed on signage that is connected to a shelf supporting the products. In other instances, signage is hung over an aisle between racks or shelving units, such as is commonly found in a grocery store or supermarket. Such displays, however, can be easily overlooked by a consumer or can be aesthetically unappealing, therefore making the conveyance of information ineffective or giving the retail environment a cluttered or unappealing appearance. Accordingly, there is a need for displaying product information in an easily viewable and aesthetically pleasing manner.

### SUMMARY OF THE INVENTION

In some aspects, a display assembly used in a retail environment is provided and includes at least one bracket connectable to a rack or like shelving unit, a display fixture supported by the bracket having indicia thereon relating to products sold in the retail environment, and a light fixture secured to the bracket and operable to illuminate the indicia on the display fixture.

In other aspects, a display assembly connectable to shelving for displaying information is provided and includes a bracket adapted to be connected to the shelving, the bracket including a first support member and a second support member. The display assembly also includes a display fixture removably supported by the first support member for displaying indicia thereon and an illumination device supported by the second support member in a position to illuminate the display fixture.

In yet other aspects, a display assembly for displaying information is provided and includes a bracket adapted to be connected to a support structure, the bracket including a first support member and a second support member. The display assembly also including a display fixture supported by the first support member and including a display panel for displaying indicia thereon. The display assembly further including an illumination device supported by the second support member in a position to illuminate the display fixture.

In still other aspects, a method of displaying information is provided and includes connecting a first bracket to a support structure, the first bracket including a first support member and a second support member, supporting a display fixture on the first support member of the first bracket, the display fixture adapted to display information, supporting an illumination device on the second support member, the illumination device adapted to illuminate the display fixture, connecting a second bracket to a second support structure, the second bracket including a third support member, removing the display fixture from the first support member of the first bracket, and supporting the display fixture on the third support member of the second bracket.

### BRIEF DESCRIPTION OF THE DRAWINGS

FIG. 1 is a front perspective view of a plurality of exemplary display assemblies secured to a rack in a retail environment.

FIG. 2 is a rear perspective view of the display assemblies shown in FIG. 1.

FIG. 3 is another rear perspective view of the display assemblies shown in FIG. 1.

FIG. 4 is a perspective view of a bracket of the display assemblies shown in FIG. 1.

FIG. 5 is a partially exploded side view of a display assembly shown in FIG. 1, with a display fixture exploded from the bracket of the display assembly.

FIG. 6 is an assembled side view of the display assembly shown in FIG. 5.

FIG. 7 is a rear perspective view of the bracket shown in FIG. 4, with the bracket connected to a cross beam.

FIG. 8 is a perspective view of another embodiment of exemplary display assemblies attached to an end cap display.

FIG. 9 is a rear perspective of a portion of the plurality of display assemblies shown in FIG. 8.

FIG. 10 is a perspective view of a bracket of the display assemblies shown in FIG. 8.

FIG. 11 is a partially exploded side view of a display assembly shown in FIG. 8, with a display fixture exploded from the bracket of the display assembly.

FIG. 12 is an assembled side view of the display assembly shown in FIG. 11.

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways.

As used herein, the terms “forward” or “front” are identified as nearest a consumer and the terms “rearward” or “back” are identified as furthest from a consumer or opposite from the forward or front. Similarly, the term “top” is identified as furthest from a ground and the term “bottom” is identified as nearest a ground or opposite the top.

### DETAILED DESCRIPTION

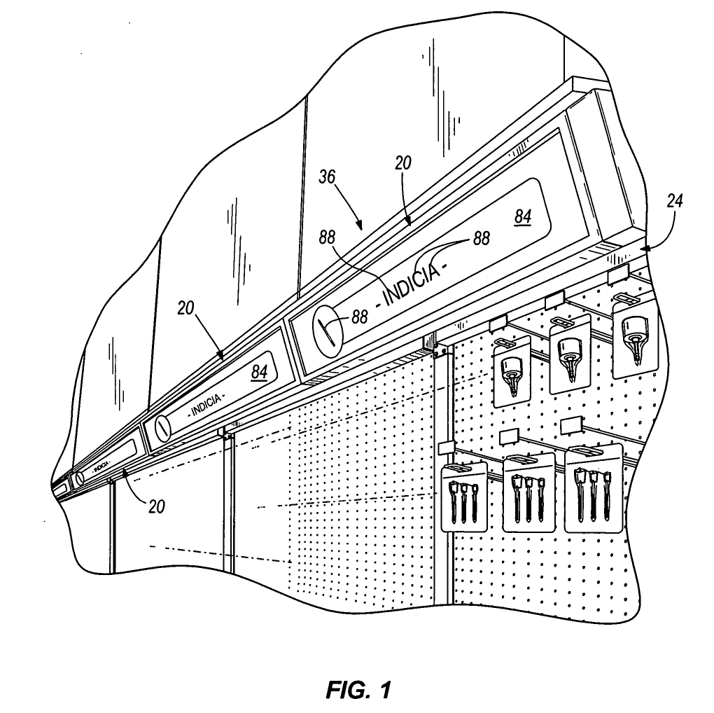

Referring to FIG. 1, a plurality of display assemblies 20 are illustrated in a retail environment for displaying and lighting information relating to consumer products sold in a retail environment. In the illustrated embodiment, the display assemblies 20 are positioned overhead of the consumer and above the products being displayed. Alternatively, the display assemblies 20 can be located in other orientations relative to the consumer and the products such as, for example, beneath the products or alongside the products.

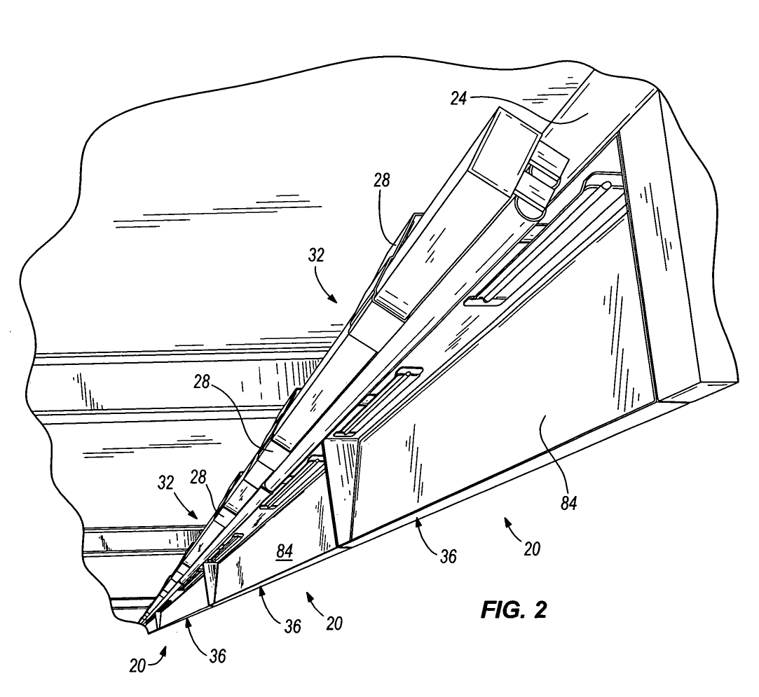

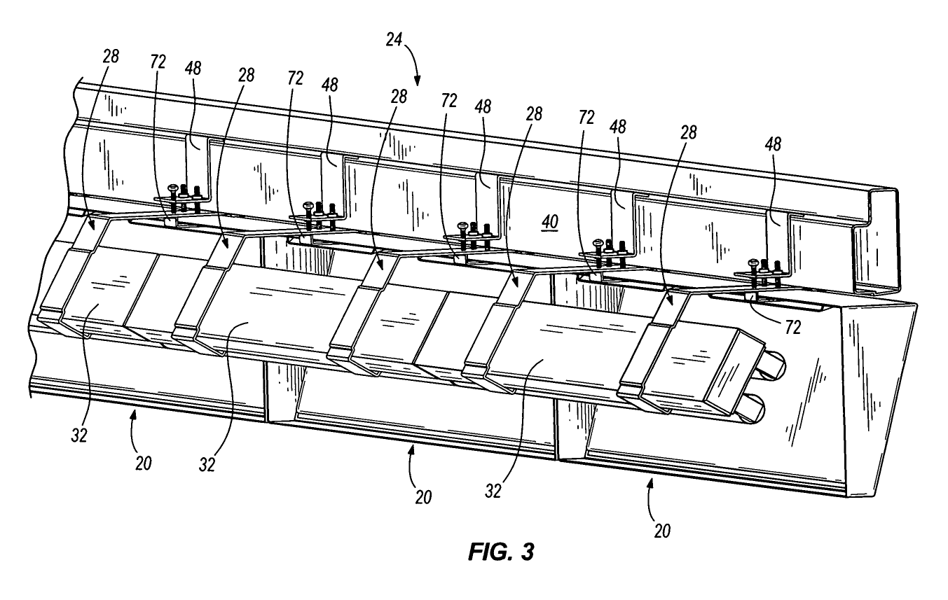

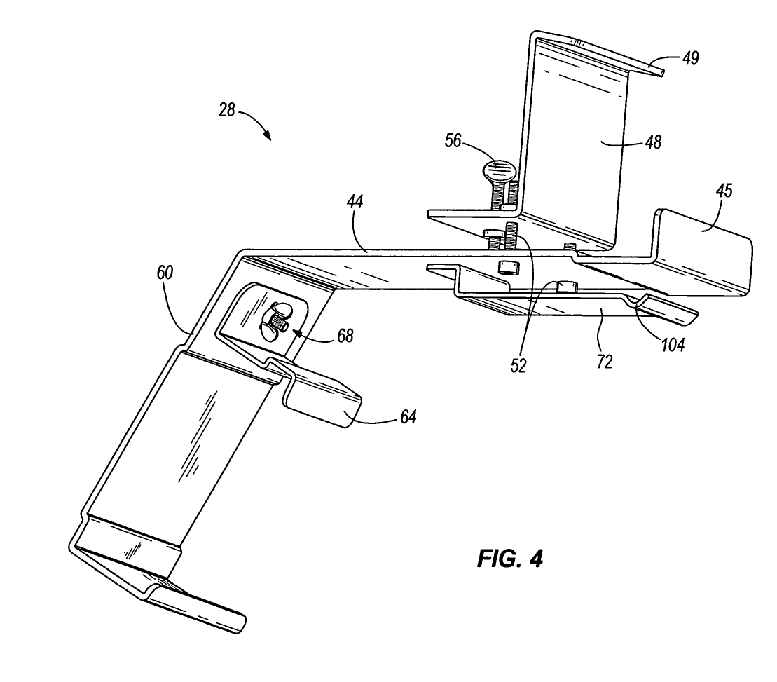

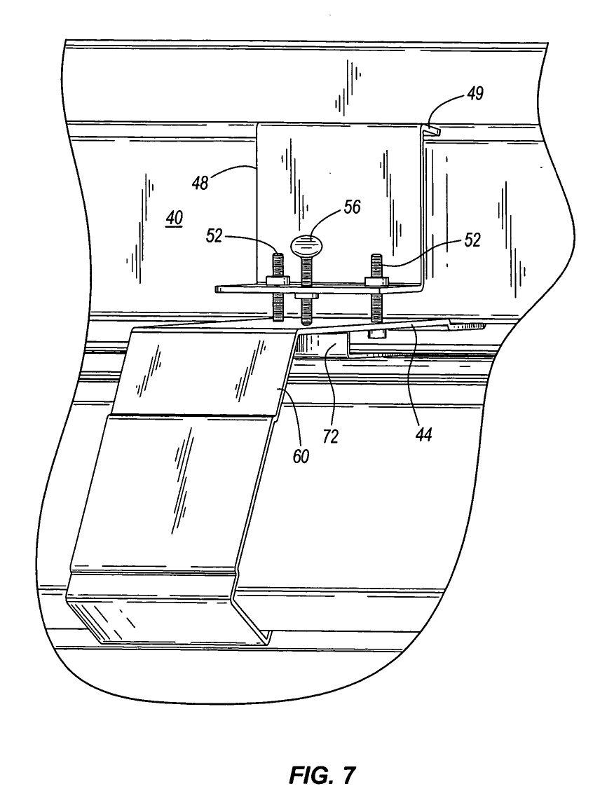

Referring now to FIGS. 1-7, the display assemblies 20 are connected to a support structure or product shelving 24 used for storing or displaying the products for sale. In the illustrated embodiment, each display assembly 20 includes two brackets 28, an illumination device or light fixture 32 and a display fixture 36. The two brackets 28 are used to connect the display assembly 20 to a cross beam 40 of the product shelving 24; however, the display assembly 20 can include any number of bracket(s) 28, including only one, to connect the display assembly 20 to the product shelving 24. Each bracket 28 includes a main portion or stationary clamp 44 positionable underneath the cross beam 40, an adjustable clamp 48 positionable above at least a portion of the cross beam 40, a pair of fasteners 52 for securing the adjustable clamp 48 relative to the stationary clamp 44 in order to clamp the bracket 28 to the cross beam 40, and an adjustment member 56, such as a thumbscrew. The clamps 44 and 48 grab and hold the cross beam 40 between them so that it fits against the front of the cross beam 40 with flange 49 resting on top of the cross beam.

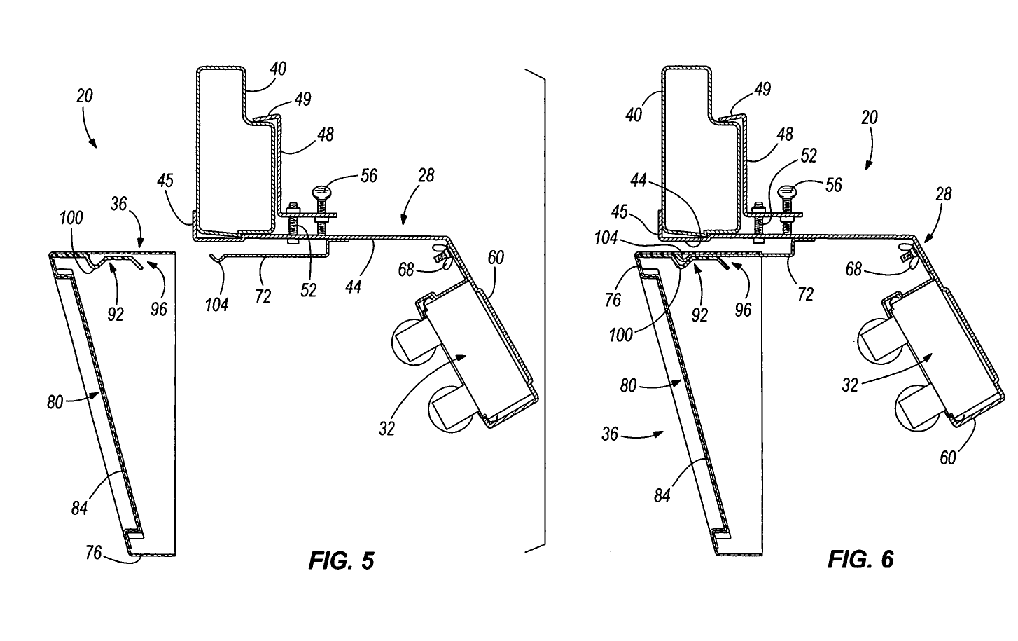

The bracket 28 connects to the cross beam 40 by sufficiently loosening the fasteners 52 to allow the stationary clamp 44 to be positioned below the cross beam 40 with the front upturned flange 45 snugly grasping the front of the cross beam 40. The adjustable clamp 48 is placed so that it grasps the rear of the cross beam 40. Next, the fasteners 52 are tightened to move the adjustable clamp 48 toward the stationary clamp 44 and to tightly grab the cross beam 40. The thumbscrew 56 is then threaded downwardly against the stationary clamp 44 to force the adjustable clamp 48 in a counter-clockwise direction (as viewed in FIGS. 5 and 6) against the cross beam 40 to maintain a tight grip and to adjust the pitch of the display fixture 36. Alternatively, the bracket 28 can be connected to the cross beam 40 by first threading the thumbscrew 56 toward the stationary clamp 44 a sufficient amount and then tightening the fasteners 52 to create the additional tension on the cross beam 40.

The bracket 28 includes a light support member including a light flange 60 extending downwardly at an obtuse angle relative to the stationary clamp 44, a light clamp 64, and a clamp fastener 68. The light fixture 32 is supported from behind and below by the light flange 60 and from above by the light clamp 64. The light clamp 64 is adjustable to facilitate installation and removal of the light fixture 32 from the bracket 28. This adjustment is performed by loosening the clamp fastener 68, which allows the light clamp 64 to move relative to the light flange 60. The light clamp 64 is movable away from the light fixture 32 to release the light fixture 32 from between the light flange 60 and the light clamp 64 or is movable downward toward the light fixture 32 and light flange 60 to secure the light fixture 32 to the bracket 28. It should be understood that the light fixture 32 can be connected to the bracket 28 in a variety of manners including, but not limited to, direct fastening, bonding, snap-fit, hook and loop fasteners, and still be within the spirit and scope of the present invention. In the illustrated embodiment, the light fixture 32 is a fluorescent light fixture; however, the light fixture can be any type of light fixture such as, for example, neon light, filament bulbs, etc.

The bracket 28 further includes a display support member 72 for supporting the display fixture 36 of the display assembly 20. The display fixture 36 includes a frame 76 defining a window 80 and an indicia panel 84 positionable in the window 80. The indicia panel 84 includes indicia 88 thereon relating to products being displayed or stored on the adjacent rack. The indicia 88 can be text, symbols, illustrations or the like. For example, if the display assembly 20 is used to sell power tools, the indicia panel 84 might include indicia 88 such as, for example, the wording “Power Tools” or “Drills,” an illustration of a drill and/or pricing information.

With particular reference to FIGS. 5 and 6, the frame 76 includes a resilient frame connection member 92 defining an opening 96 and a U-shaped detent 100 inwardly of the opening 96. The frame 76 is connected to the bracket 28 by aligning the opening 96 of the frame connection member 92 with the support member 72 of the bracket 28. The frame 76 is forced onto the support member 72, which inserts the support member 72 into the opening 96 and deflects the resilient frame connection member 92. The support member 72 includes a projection 104 complementarily shaped to the detent 100 in the frame connection member 92. The frame 76 slides along the support member 72 until the projection 104 resides in the detent 100, which allows the frame connection member 92 to substantially return to its original, non-deflected state and thus hold the frame 76 to the support member 72. In this assembled state, the light fixture 32 is appropriately positioned behind the indicia panel 84 so as to illuminate the indicia panel 84. The indicia panel 84 is made of an appropriate material, at least partially transparent, so that the light emitted by the light fixture 32 illuminates the indicia 88 on the indicia panel 84.

In the illustrated embodiment, the indicia panel 84 is inclined relative to the vertical so that the indicia panel 88 can be easily viewed from below by a consumer. To provide sufficient and evenly dispersed lighting to illuminate the indicia panel 84, the light flange 60 is angled obtusely relative to the stationary clamp 44 to orient the light fixture 32 substantially parallel to the indicia panel 84.

The display fixture 36 of the display assembly 20 is easily removable from the brackets 28 to allow interchangeability of display fixtures 36. This interchangeability provides the display assembly 20 modularity in a variety of retail environments. Often times, products are moved from place to place in a store and, consequentially, the respective display fixtures 36 must be changed as well. Since the brackets 28 can remain connected to the product shelving 24 and the display fixture 36 is easily removed from the brackets 28, the display fixture 36 can simply be pulled from the brackets 28 in a first location and easily installed in a second location in the store by placing them on brackets 28 already connected to the product shelving 24 in the second location.

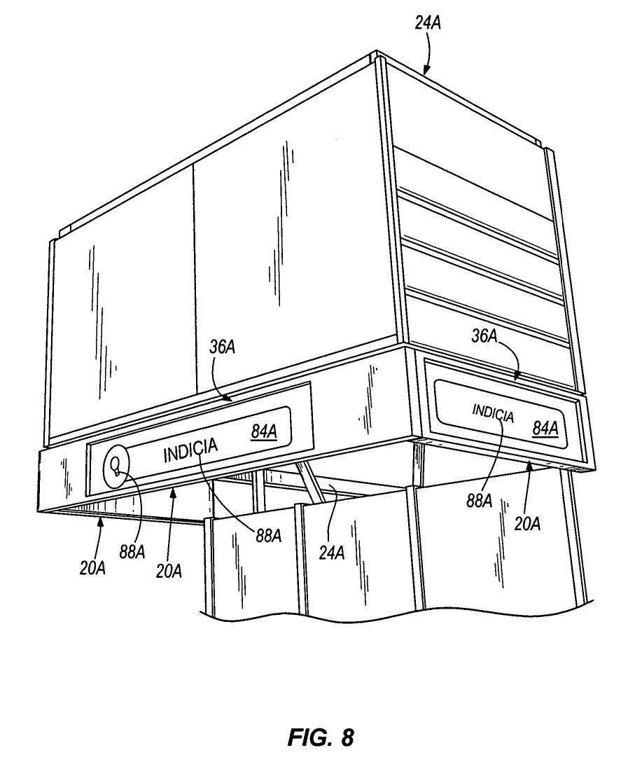

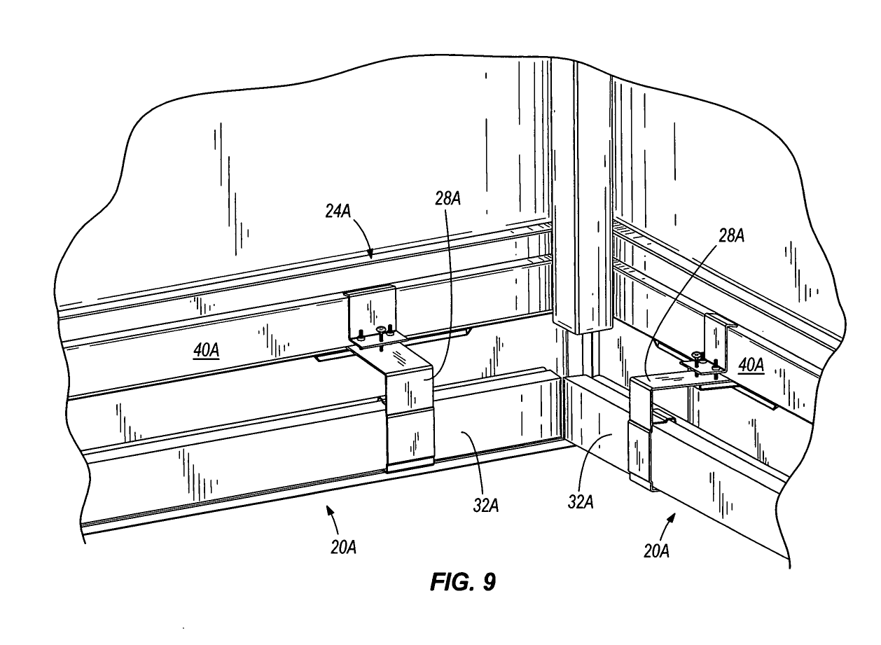

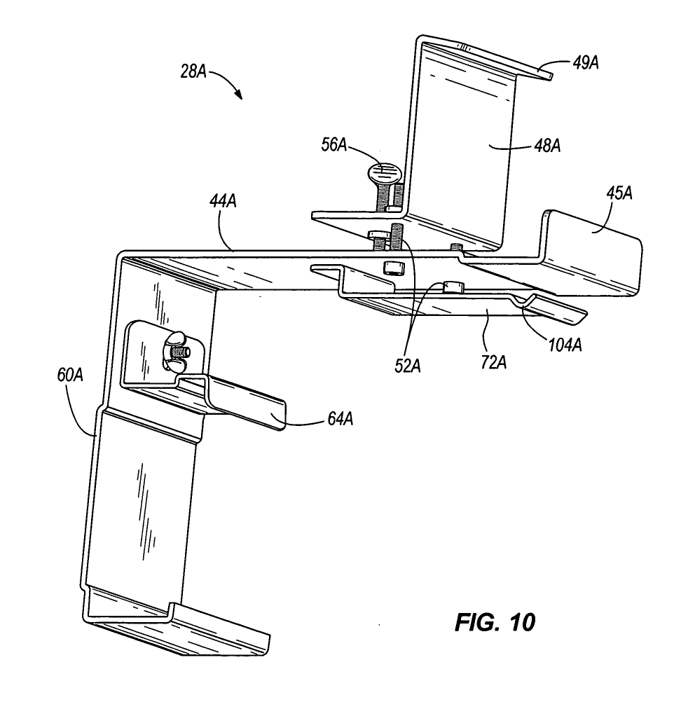

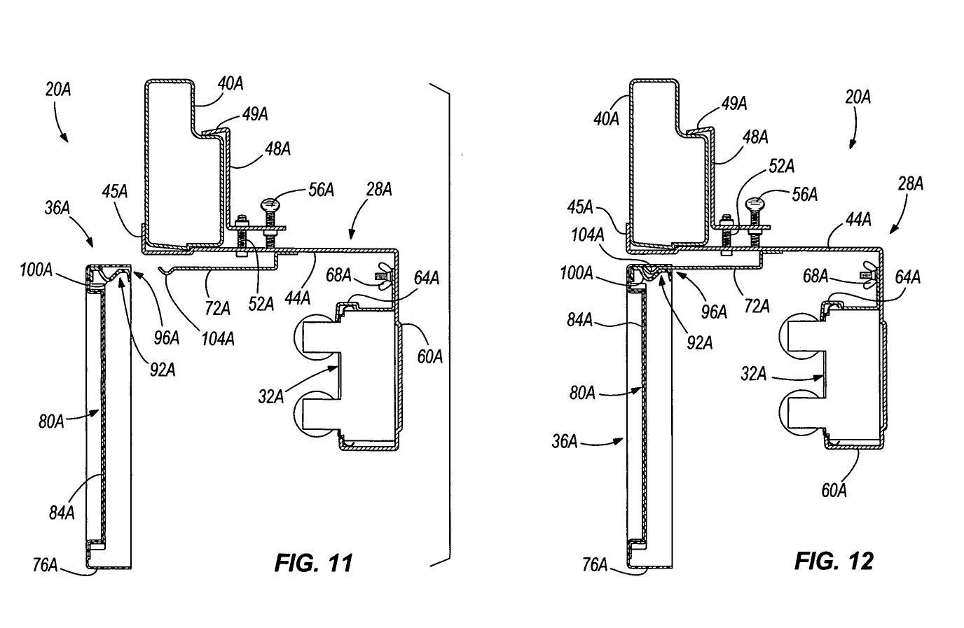

Referring to FIGS. 8-12, another embodiment of a display assembly 20A is illustrated. The display assembly 20A illustrated in FIGS. 8-12 is similar to the display assembly 20 illustrated in FIGS. 1-7. Accordingly, components of the display assembly 20A illustrated in FIGS. 8-12 that are similar to the components of the display assembly 20 illustrated in FIGS. 1-7 will be referenced with an “A” and only differences between the assemblies will be described herein.

The display assemblies 20A can be positioned at the ends of retail aisles and the indicia panels 84A are oriented substantially vertical to facilitate viewing of the indicia panels 84A from relatively long distances. The light flange 60A also extends substantially perpendicularly from the stationary clamp 44A in order to orient the light fixture 32 substantially vertical relative to the floor and substantially parallel to the vertically oriented indicia panel 84A. The parallel orientations of the indicia panel 84A and the light fixture 32 provide sufficient and evenly dispersed light to illuminate the indicia panel 84A.

Although particular constructions of the present invention have been shown and described, other alternative constructions will be apparent to those skilled in the art and are within the intended scope of the present invention.

What is claimed is:

1. A display assembly connectable to shelving for displaying information, the display assembly comprising:
a bracket adapted to be connected to the shelving, the bracket including a first support member and a second support member;
a display fixture supported by the first support member for displaying indicia thereon; and
an illumination device supported by the second support member in a position to illuminate the display fixture.

2. The display assembly of claim 1, wherein the first support member includes one of a projection and a detent and the display fixture includes the other of the projection and the detent, the projection and detent being complimentarily shaped to engage each other and facilitate removable connection of the display fixture to the bracket.

3. The display assembly of claim 2, wherein the display fixture can slide onto and off of the first support member.

4. The display assembly of claim 1, wherein the first support member includes a projection and the display fixture includes a connection member defining an opening and a detent, wherein a portion of the first support member including the projection is inserted into the opening to position the projection in the detent and removably support the display fixture on the first support member.

5. The display assembly of claim 1, wherein the bracket includes a first portion extending at least partially underneath a cross-beam of the shelving and a second portion extending at least partially above a top of the cross beam to connect the bracket to the shelving.

6. The display assembly of claim 5, wherein one of the first portion and the second portion is movable relative to the other of the first portion and the second portion.

7. The display assembly of claim 6, wherein the bracket includes a fastener for moving the one of the first portion and the second portion relative to the other of the first portion and the second portion.

8. The display assembly of claim 7, further comprising an adjustment member coupled to the first portion and the second portion to adjust the pitch of the display fixture.

9. The display assembly of claim 7, wherein the fastener is a first fastener, the bracket including a second fastener, the first and second fasteners moving the one of the first portion and the second portion of the bracket relative to the other of the first portion and the second portion to removably connect the bracket to the cross-beam.

10. The display assembly of claim 6, wherein the second portion is movable relative to the first portion.

11. The display assembly of claim 1, further comprising an adjustment member coupled to the bracket to adjust the pitch of the display fixture.

12. The display assembly of claim 1, wherein the display fixture includes a display panel, the indicia being positioned on the display panel.

13. The display assembly of claim 12, wherein the display panel and the illumination device are disposed at an angle relative to vertical.

14. The display assembly of claim 12, wherein the display panel and the illumination device are substantially vertical.

15. The display assembly of claim 1, wherein the bracket includes a main portion substantially horizontal when the bracket is connected to the shelving, wherein the first support member extends below and forward from the main portion and the second support member extends below and rearward from the main portion.

16. The display assembly of claim 1, wherein the second support member includes a first portion and a second portion movable relative to the first portion, the second portion being movable relative to the first portion to facilitate selective removal of the illumination device from the second support member of the bracket.

17. The display assembly of claim 16, wherein the first portion of the second support member extends at least partially around a bottom and at least partially around the front of the illumination device and the second portion of the second support member extends at least partially above a top and at least partially around a front of the illumination device.

18. The display assembly of claim 1, wherein the bracket is a first bracket, the display assembly further comprising a second bracket connected to the shelving, the first bracket and the second bracket together supporting the display fixture and the illumination device.

19. The display assembly of claim 1, wherein the display fixture is removably supported by the first support member.

20. A display assembly for displaying information, the display assembly comprising:
a bracket adapted to be connected to a support structure, the bracket including a first support member and a second support member;
a display fixture supported by the first support member and including a display panel for displaying indicia thereon; and
an illumination device supported by the second support member in a position to illuminate the display fixture.

21. The display assembly of claim 20, wherein the display panel and the illumination device are substantially parallel with each other.

22. The display assembly of claim 20, wherein the display panel and the illumination device are disposed at an angle relative to vertical.

23. The display assembly of claim 20, wherein the display panel and the illumination device are disposed substantially vertical.

24. The display assembly of claim 20, wherein the display fixture is removably supported by the first support member.

25. A method of displaying information comprising:
connecting a first bracket to a support structure, the first bracket including a first support member and a second support member;
supporting a display fixture on the first support member of the first bracket, the display fixture adapted to display information;
supporting an illumination device on the second support member, the illumination device adapted to illuminate the display fixture;
connecting a second bracket to a second support structure, the second bracket including a third support member;
removing the display fixture from the first support member of the first bracket; and
supporting the display fixture on the third support member of the second bracket.

26. The method of claim 25, wherein the second bracket includes a fourth support member, the method further comprising supporting a second illumination device on the fourth support member of the second bracket.

27. The method of claim 25, wherein the first support member includes one of a projection and a detent and the display fixture includes a connection member including the other of the projection and the detent, the method further comprising engaging a portion of the first support member including the one of the projection and detent with a portion of the connection member including the other of the projection and the detent to secure the display fixture to the bracket.

28. The method of claim 25, wherein the support structure is a cross-beam of shelving.
